(19) United States
(12) Patent Application Publication
(10) Pub. No.: US 2018/0348514 A1
(43) Pub. Date: Dec. 6, 2018

(54) HEAD-UP DISPLAY FOR A VEHICLE AND VEHICLE EQUIPPED WITH SUCH A DEVICE

(71) Applicant: VALEO COMFORT AND DRIVING ASSISTANCE, Créteil (FR)

(72) Inventors: François Grandclerc, Créteil (FR); Pierre Mermillod, Créteil (FR)

(73) Assignee: VALEO COMFORT AND DRIVING ASSISTANCE, Créteil (FR)

(21) Appl. No.: 15/778,295

(22) PCT Filed: Nov. 23, 2016
(86) PCT No.: PCT/EP2016/078583

§ 371 Date: May 23, 2018

(30) Foreign Application Priority Data
Nov. 23, 2015 (FR) 1561257

(51) Int. Cl. G02B 27/01; G09G 3/3208; B60K 35/00; B60Q 9/00

(52) U.S. Cl. CPC G02B 27/0101; G09G 3/3208; B60K 35/00; B60K 2350/2052; G09G 2380/10; G02B 2027/0141; B60Q 9/00

(57) ABSTRACT

The invention relates to a head-up display device (1) for a vehicle (2) comprising:—an image generating unit (4) generating a primary light beam (7) representing a scene to be displayed, and—an optical projection system (8, 9) for projecting this scene onto an individual (3) situated inside the vehicle, the optical projection system comprising a return mirror (8) having a first face (10) and a second face (11), the first face being turned towards the image generating unit so as to reflect the primary light beam towards a combiner (9) adapted to form an image (16) of the scene visible by the individual. According to the invention, the device comprises at least one element (18) facing the second face of the return mirror and adapted to emit a secondary light beam (19) in the direction of this second face, the secondary light beam being transmitted through the return mirror towards the combiner forming an image (20) of the element visible by the individual.

### TECHNICAL FIELD TO WHICH THE INVENTION RELATES

The present invention generally relates to the field of driver-assistance systems for vehicles.

It more particularly relates to a head-up display device for a vehicle.

It also relates to a vehicle equipped with such a head-up display device.

### TECHNOLOGICAL BACKGROUND

In the prior art, head-up display devices for vehicles are known, these devices including:
an image-generating unit that generates a primary light beam that represents a scene to be displayed; and
an optical system for projecting said scene to an individual located in the interior of said vehicle, said projecting optical system comprising a steering mirror having a first face and a second face, said first face being turned toward said image-generating unit in order to reflect said primary light beam toward a combiner suitable for forming an image that may be seen by said individual of said scene.

These head-up display devices prove to be useful in the assistance of the driver of a vehicle with driving. They in particular allow information relating to safety, to the environment of the vehicle or indeed to navigation to be projected into the field of view of the driver, and in superposition with his view of the road on which he is driving.

The image-generating units used in these devices are complex electronic systems that may malfunction so that safety-related information (vehicle anomaly detected, collision with another vehicle) may no longer be displayed when an imminent danger is detected.

### SUBJECT OF THE INVENTION

In order to remedy the aforementioned drawbacks of the prior art, the present invention provides a display device allowing an additional image to be displayed to an individual located in the interior of the vehicle without passing via the image-generating unit.

More particularly, according to the invention, a head-up display device such as defined in the introduction is provided, this device including at least one element facing said second face of the steering mirror and suitable for emitting a secondary light beam in the direction of said second face, said secondary light beam being transmitted through said steering mirror toward said combiner, forming an image that may be seen by said individual of said element.

Thus, by virtue of the head-up display device of the invention, even if the image-generating unit malfunctions, it is still possible, via the element emitting the secondary light beam, to project, through the projecting optical system, important information into the field of view of the individual.

The following are other nonlimiting and advantageous features of the head-up display device according to the invention, which may be implemented individually or in any technically possible combination:
said element comprises a luminous pattern forming a signaling, warning or alarm status light;
said element comprises an electroluminescent light source;
said light source is an organic light-emitting diode;
the intensity and/or the spectrum of the secondary light beam emitted by said element are modulated over time;
said element occupies a preset position with respect to said steering mirror so that said image of the element may be seen by the individual in a privileged direction in which he sees a central portion of said image of the scene projected by the projecting optical system;
the head-up display device includes an optical system interposed between said steering mirror and said element and intended to form an intermediate image of said element;
said combiner forming said image of the scene at a first image-distance from the individual, said optical system has optical properties and a relative position with respect to said element and to said steering mirror that are set so that the combiner forms said image of the element at a second image-distance from the individual that is substantially equal to said first image-distance;
said steering mirror has, with respect to said secondary light beam, a transmission coefficient, for transmission between its second face and its first face, higher than or equal to 10%;
said combiner has, with respect to said secondary light beam, a reflection coefficient higher than or equal to 20%;
said image-generating unit comprises an active luminous screen.

The invention also provides a vehicle equipped with a head-up display device according to the invention.

### DETAILED DESCRIPTION OF ONE EXAMPLE EMBODIMENT

The following description with reference to the appended drawings, which are given by way of nonlimiting example, will allow of what the invention consists and how it may be carried out to be clearly understood.

In the appended drawings:

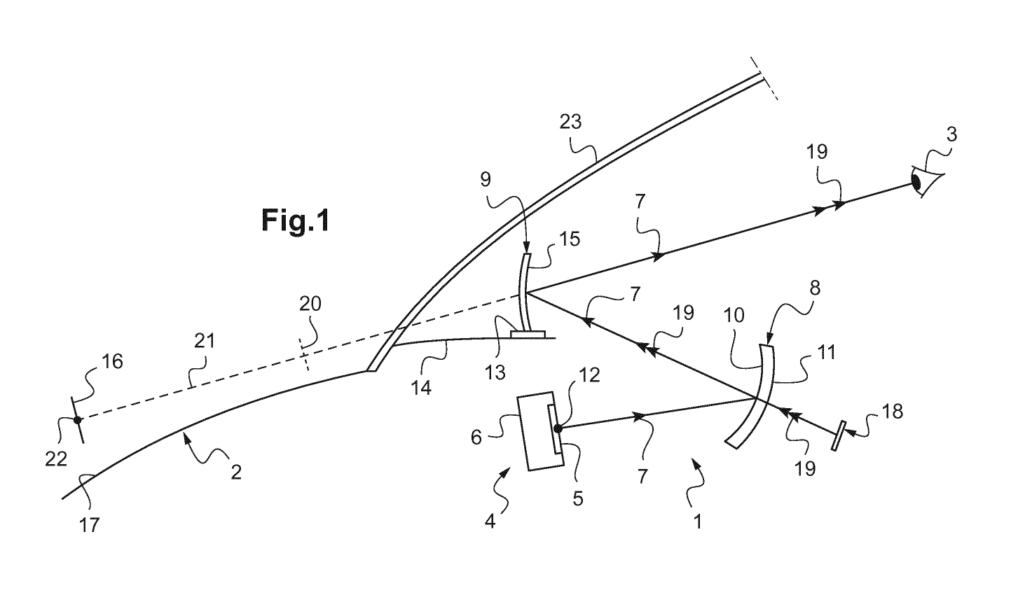

FIG. 1 is a partial cross-sectional overview of a motor vehicle including a head-up display device according to one preferred embodiment of the invention;

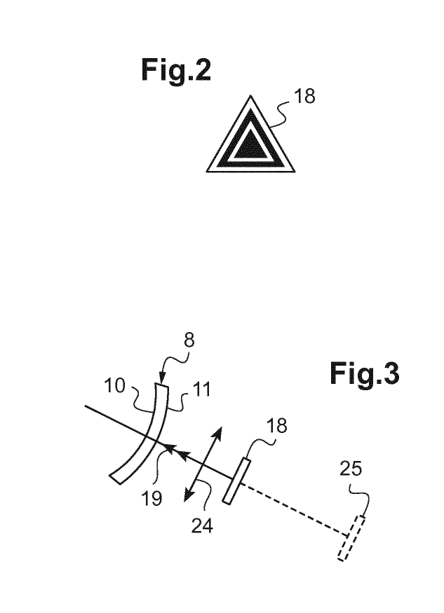

FIG. 2 is an example of a luminous element able to be integrated into the device of FIG. 1 and representing an alarm status light; and

FIG. 3 is a partial view of a variant embodiment of a head-up display device including a lens interposed between the steering mirror and the luminous element forming an alarm status light.

FIG. 1 shows a head-up display device 1, which will be referred to as the “head-up display” or more simply the “display” below, with which a vehicle, here a motor-vehicle 2, is equipped.

Generally, this display 1 is intended to project images into the field of view of an individual 3 located in the interior of the vehicle 2 (in FIG. 1 only the eyes of the individual 3 have been shown). In the rest of the description, this individual 3 will be considered to be the driver of the motor vehicle 2.

These images may for example comprise information relating to the vehicle 2 (speed, engine rpm, petrol level, distance with respect to other vehicles, etc.) or even instructions as to the itinerary to be followed by the vehicle 2 (in association with an on-board navigation system for example).

To project these images, the display 1 firstly includes an image-generating unit 4 that preferably comprises an active luminous screen 5 that here is mounted in a housing 6 that forms a holder for the screen 5.

The screen 5 is here a thin-film-transistor (TFT) liquid-crystal-display (LCD) screen.

The housing 6 contains a controller (not shown) that controls the screen 5, that receives signals originating from the on-board computer of the vehicle 2, and that drives the screen 5 accordingly in order to display a scene on the latter.

In other words, when the screen 5 is driven by the controller, the image-generating unit 4 generates a primary light beam 7 (only one primary light ray originating from the center 12 of the screen 5 is shown in FIG. 1) that represents this scene to be projected into the field of view of the driver 3.

To this end, the display 1 also includes an optical system for projecting the scene to the driver 3 located in the interior of the vehicle 2.

This projecting optical system in particular comprises a steering mirror 8 and a combiner 9.

The steering mirror 8 is here a spherical mirror having a first face 10 and a second face 11.

As a variant, the steering mirror may be a plane mirror or indeed a mirror of parabolic, elliptical or aspherical shape.

As shown in FIG. 1, the first face 10 is the face that is turned toward the image-generating unit 4, and more precisely toward the screen 5, so as to intercept the primary light beam 7 generated by the display of the scene on the screen 5.

The first face 10 of the steering mirror 8 preferably comprises an optical coating suitable for reflecting the primary light beam 7 toward the combiner 9. This optical coating may for example comprise a metal layer or indeed a stack of dielectric layers the optical properties of which (number of layers, refractive indices and thicknesses of the layers) are optimized for reflection of the primary light beam 7.

In the particular embodiment illustrated in FIG. 1, the combiner 9 is placed between the windshield 23 of the vehicle 2 and the eyes of the driver 3 and is mounted on a plinth 13 that is placed in a dashboard 14 of the vehicle 2.

Advantageously, provision could be made, between the combiner and the plinth, for means for adjusting the combiner, allowing its position and/or its orientation with respect to the dashboard to be modified.

The combiner 9 comprises a front face 15 that is turned toward the interior of the passenger compartment of the vehicle 2, i.e. toward the driver 3. This front face 15 faces, at least partially, the first face 10 of the steering mirror 8 so as to intercept the primary light beam 7 reflected by the steering mirror 8.

The front face 15 of the combiner 9 preferably comprises a partially reflective coating (not shown), for example with an average reflection coefficient comprised between 20% and 35%.

By virtue of this reflective coating, the front face 15 of the combiner 9 reflects the primary light beam 7 in the direction of the driver 3 and forms an image 16 that may be seen by the driver 3 of the scene generated by the screen 5.

As a variant, the front face of the combiner may be bare, i.e. not coated with a reflective coating. The reflective properties of the bare surface are then used to reflect the primary light beam. In this case, the average reflection coefficient of the front face of the combiner may be lower than 20%.

Advantageously, the screen 5, the steering mirror 8 and the combiner 9 are arranged, with respect to one another, so that the display 1 projects the image 16 of the scene into the field of view of the driver 3 but on the exterior of the vehicle 2, here in the region of the front of the hood 17 of the vehicle 2.

This image 16 of the scene is formed at a first image-distance from the driver 3, which is generally comprised between 1.8 and 2.5 meters.

More precisely, the image 16 of the scene is projected, by the projecting optical system, in a privileged direction 21 (see FIG. 1) in which the driver 3 sees a central portion of this image 16. This privileged direction 21 associated with the central portion of the image 16 of the scene corresponds to the gaze direction of the driver 3 when the latter is looking at the image-point 22 corresponding to the image of the center 12 of the screen 5 formed by the projecting optical system.

As the combiner 9 is partially transparent, the image 16 of the scene may be seen by the driver 3 without the latter having to divert his gaze from the road too much when he is driving.

In order to be able to display, in the field of view of the driver 3, an image other than the image 16 of the scene generated by the image-generating unit 4, the display 1 includes, according to the invention (see FIG. 1), an element 18 facing the second face 11 of the steering mirror 8 and suitable for emitting a secondary light beam 19 in the direction of this second face 11, the secondary light beam 19 being transmitted through the steering mirror 8 toward the combiner 9, forming an image 20 that may be seen by the driver 3 of this element 18.

Thus, even if the image-generating unit 4 malfunctions or is no longer able to operate, the display 1 is able to nonetheless display another image, the image 20 of the element 18, in the field of view of the driver 3.

In order to make the image 20 of the element 18 sufficiently visible to the driver 3, the steering mirror 8 has, with respect to the secondary light beam 19, a transmission coefficient, for transmission between its second face 11 and its first face 10, higher than a preset minimum transmission coefficient. Preferably, the transmission coefficient of the steering mirror 8 is higher than or equal to 10%.

Likewise, the combiner has, with respect to the secondary light beam 19, a reflection coefficient for reflection from its front face 15 that is higher than a preset minimum reflection coefficient. Preferably, the reflection coefficient of the front face 15 of the combiner 9 is higher than or equal to 20%.

Preferably, the element 18 comprises a luminous indicator or pattern forming a signaling, warning or alarm status light.

Warning status lights may for example signal to the driver 3 an engine fault indicating a need to stop immediately or a danger to the passengers of the vehicle 2 (engine overheating, failure of the braking system, seat belts not fastened, etc.).

Advisory status lights may for example signal to the driver 3 a fault in an on-board electronic system or the need to promptly inspect a unit of the vehicle, while leaving the driver free to continue to use the vehicle (failure of the airbag system, low fuel level, malfunction of the wheel anti-lock system, etc.).

Signaling status lights signal the operation or activation of an on-board system (lights turned on, parking brake engaged, windscreen wipers on, etc.).

An example of one possible luminous pattern is shown in FIG. 2. This luminous pattern 18 represents an alarm status light indicating to the driver 3 of the vehicle that a danger is imminent. Other luminous patterns are possible.

Advantageously, the element 18 is driven so that the intensity or the spectrum of the secondary light beam 19 emitted by the element 18 is modulated over time. This for example allows the color of the image 20 of the element 18 seen by the driver 3 to be varied depending on the imminence of a danger. For example, the luminous pattern may be displayed in yellow when there remains enough fuel to go 50 kilometers, in orange when there remains enough to go 20 km and in red when there remains enough to go 10 km.

It may also be envisioned to make the luminous pattern flash in order to draw the attention of the driver 3 to the image 20 of the element.

In the preferred embodiment shown in FIG. 1, the element 18 comprises an electroluminescent light source, of the organic light-emitting diode type. This type of light source may be supplied directly with DC current from the battery (optionally with a step-down voltage converter) and has the advantages of consuming little power and of having a very long lifetime—typically at least ten thousand hours.

In addition, the OLED-based element 18 may be easily defined to the shape of the luminous pattern to be displayed.

As shown in FIG. 1, the element 18 is placed, with respect to the steering mirror 8, so that the image 20 of the element 18 may be seen by the driver 3 in the privileged direction 21 associated with the central portion (see image-point 22) of the image 16 of the scene projected by the projecting optical system. In this way, it is ensured that the image 20 of the element 18 may indeed be seen when the latter emits the secondary light beam 19.

In practice, for reasons of overall bulk of the display 1 in the passenger compartment of the vehicle 2, the distance between the element 18 and the second face 11 (back face) of the steering mirror 8 is different from, and generally smaller than, the distance separating the screen 5 from the first face 10 (front face) of the steering mirror 8.

In other words, the element 18 occupies a position with respect to the steering mirror 8 that is such that the combiner 9 forms the image 20 of the element 18 at a second image-distance from the driver 3 that is smaller than the first image-distance of the image 16 of the scene.

In this case, the image 20 of the element 18 will appear slightly blurred to the driver 3 looking at the image 16 of the scene.

Advantageously, as FIG. 3 shows, the display 1 may then comprise an optical system 24 interposed between the steering mirror 8 and the element 18 and intended to form an intermediate image 25 of the element 18.

Preferably, this optical system 24 has optical properties and a relative position with respect to the element 18 and to the steering mirror 8 that are set so that the combiner (9) forms said image (20) of the element (18) at a second image-distance from the individual (3) that is substantially equal to said first image-distance.

In other words, the optical system 24 is designed so that the combiner (9) forms said image (20) of the element (18) in an image plane that is substantially coincident with the image plane of the image 16 of the scene.

The distance between the intermediate image 25 and the steering mirror 8 is then substantially equal to the distance between the screen 5 and the steering mirror 8.

In the example shown here in FIG. 3, the optical system 24 comprises a single convergent lens placed at a distance from the element 18 that is smaller than its focal length. The intermediate image 25 of the element 18 therefore forms behind the element 18, i.e. at a greater distance from the steering mirror 8.

The intermediate image 25 is then projected by the steering mirror 8 (operation in transmission) and the combiner 9 into an image plane that is substantially coincident with the image plane of the image 16 of the scene. In this way, the driver 3 simultaneously sees clearly both the image 16 of the scene and the image 20 of the element 18.

Provision may also be made for the element 18 of the display 1 to have a non-planar shape that is set so as to correct optical aberrations in the image 20 of the element 18. This may easily be done when the element 18 comprises an OLED light source by deforming the substrate of the diode.

The present invention is in no way limited to the embodiment described and shown, and those skilled in the art will be able to incorporate into it any variant in accordance with its spirit.

Thus, instead of the steering mirror, a more complex optical system comprising a plurality of mirrors and/or other optical elements could be used.

Provision could also be made for the combiner to be formed by the windshield of the vehicle. In this case, the two glass sheets forming said windshield may advantageously be laminated with a wedge- or prism-shaped lamination interlayer. This allows the parasitic effect of “double images” resulting from reflection toward the driver of the light beams from the two glass sheets to be avoided.

In another embodiment, the element could comprise an OLED light source deposited on the back face of the steering mirror.

1. A head-up display device for a vehicle, comprising:
an image-generating unit that generates a primary light beam that represents a scene to be displayed; and
an optical system for projecting said scene to an individual located in the interior of said vehicle, said projecting optical system comprising a steering mirror having a first face and a second face, said first face being turned toward said image-generating unit to reflect said primary light beam toward a combiner for forming an image seen by said individual of said scene; and
at least one element facing said second face of the steering mirror and suitable for emitting a secondary light beam in the direction of said second face, said secondary light beam being transmitted through said steering mirror toward said combiner, forming an image seen by said individual of said element.

2. The head-up display device as claimed in claim 1, wherein said element comprises a luminous pattern forming a signaling, warning or alarm status light.

3. The head-up display device as claimed in claim 1, wherein said element comprises an electroluminescent light source.

4. The head-up display device as claimed in claim 3, wherein said light source is an organic light-emitting diode.

5. The head-up display device as claimed in claim 1, wherein the intensity and/or the spectrum of the secondary light beam emitted by said element are modulated over time.

6. The head-up display device as claimed in claim 1, wherein said element occupies a preset position with respect to said steering mirror so that said image of the element is seen by the individual in a privileged direction in which the individual sees a central portion of said image of the scene projected by the projecting optical system.

7. The head-up display device as claimed in claim 1, further comprising an optical system interposed between said steering mirror and said element and configured to form an intermediate image of said element.

8. The head-up display device as claimed in claim 7, wherein, said combiner forming said image of the scene at a first image-distance from the individual, said optical system has optical properties and a relative position with respect to said element and to said steering mirror that are set so that the combiner forms said image of the element at a second image-distance from the individual that is substantially equal to said first image-distance.

9. The head-up display device as claimed in claim 1, wherein said steering mirror has, with respect to said secondary light beam, a transmission coefficient, for transmission between a second face and a first face of the steering mirror, higher than or equal to 10%.

10. The head-up display device as claimed in claim 1, wherein said combiner has, with respect to said secondary light beam, a reflection coefficient higher than or equal to 20%.

11. The head-up display device as claimed in claim 1, wherein said image-generating unit comprises an active luminous screen.

12. A vehicle equipped with a head-up display device as claimed in claim 1.
